(19) United States
(12) Patent Application Publication
(10) Pub. No.: US 2005/0270312 A1
(43) Pub. Date: Dec. 8, 2005

(54) Fluid dispensing and drop-on-demand dispensing for nano-scale manufacturing

(75) Inventors: Pankaj B. Lad, Austin, TX (US); Ian M. McMackin, Austin, TX (US); Van N. Truskett, Austin, TX (US); Norman E. Schumaker, Austin, TX (US); Sidlgata V. Sreenivasan, Austin, TX (US); Duane Voth, Austin, TX (US); Philip D. Schumaker, Austin, TX (US); Edward B. Fletcher, Austin, TX (US)

Correspondence Address: MOLECULAR IMPRINTS, INC.;KENNETH C. BROOKS, PO BOX 81536, AUSTIN, TX, 78708-1536, US

(73) Assignee: Molecular Imprints, Inc.

(21) Appl. No.: 11/143,092

(22) Filed: Jun. 2, 2005

Related U.S. Application Data
(60) Provisional application No. 60/576,878, filed on Jun. 3, 2004.

(51) Int. Cl. B41J 2/01

(52) U.S. Cl. 347/1

(57) ABSTRACT

The present invention is directed to a method for dispensing a total volume of liquid on a substrate, the method including, inter alia, disposing a plurality of spaced-apart droplets on a region of the substrate, each having an unit volume associated therewith, with an aggregate volume of the droplets in the region being a function of a volume of a pattern to be formed thereat.

### CROSS-REFERENCE TO RELATED APPLICATIONS

The present application claims priority to U.S. provisional patent application No. 60/576,878 filed on Jun. 3, 2004, entitled “Fluid Dispensing and Drop-on-Demand Dispensing for Nano-Scale Manufacturing,” which is incorporated by reference herein.

### BACKGROUND OF THE INVENTION

The field of the invention relates generally to imprint lithography. More particularly, the present invention is directed to a method of dispensing a volume of a liquid on a substrate to reduce the time required to fill the features of a template during imprint lithography processes.

Micro-fabrication involves the fabrication of very small structures, e.g., having features on the order of micro-meters or smaller. One area in which micro-fabrication has had a sizeable impact is in the processing of integrated circuits. As the semiconductor processing industry continues to strive for larger production yields while increasing the circuits per unit area formed on a substrate, micro-fabrication becomes increasingly important. Micro-fabrication provides greater process control while allowing increased reduction of the minimum feature dimension of the structures formed. Other areas of development in which micro-fabrication has been employed include biotechnology, optical technology, mechanical systems and the like.

An exemplary micro-fabrication technique is shown in U. S. Pat. No. 6,334,960 to Willson et al. Willson et al. disclose a method of forming a relief image in a structure. The method includes providing a substrate having a transfer layer. The transfer layer is covered with a polymerizable fluid composition. A mold makes mechanical contact with the polymerizable fluid. The mold includes a relief structure, and the polymerizable fluid composition fills the relief structure. The polymerizable fluid composition is then subjected to conditions to solidify and to polymerize the same, forming a solidified polymeric material on the transfer layer that contains a relief structure complimentary to that of the mold. The mold is then separated from the solid polymeric material such that a replica of the relief structure in the mold is formed in the solidified polymeric material. The transfer layer and the solidified polymeric material are subjected to an environment to selectively etch the transfer layer relative to the solidified polymeric material such that a relief image is formed in the transfer layer. The time required and the minimum feature dimension provided by this technique are dependent upon, inter alia, the composition of the polymerizable material.

It is desired, therefore, to provide a technique that decreases the time required to fill a feature of an imprint lithography template.

### SUMMARY OF THE INVENTION

The present invention is directed to a method for dispensing a total volume of liquid on a substrate, the method including, inter alia, disposing a plurality of spaced-apart droplets on a region of the substrate, each having an unit volume associated therewith, with an aggregate volume of the droplets in the region being a function of a volume of a pattern to be formed thereat. These other embodiments are discussed more fully below.

### BRIEF DESCRIPTION OF THE DRAWINGS

FIG. 1 is a perspective view of a lithographic system in accordance with the present invention;

FIG. 2 is a simplified elevation view of a lithographic system shown in FIG. 1;

FIG. 3 is a simplified representation of material from which an imprinting layer, shown in FIG. 2, is comprised before being polymerized and cross-linked;

FIG. 4 is a simplified representation of cross-linked polymer material into which the material shown in FIG. 3 is transformed after being subjected to radiation;

FIG. 5 is a simplified elevation view of a mold spaced-apart from the imprinting layer, shown in FIG. 1, after patterning of the imprinting layer;

FIG. 6 is a top down view showing an array of droplets of imprinting material deposited upon a region of the substrate shown above in FIG. 2 in accordance with a first embodiment of the present invention; and

FIG. 7 is a flow diagram showing a method of dispensing droplets on a region of a substrate as a function of a design of a template.

### DETAILED DESCRIPTION OF THE INVENTION

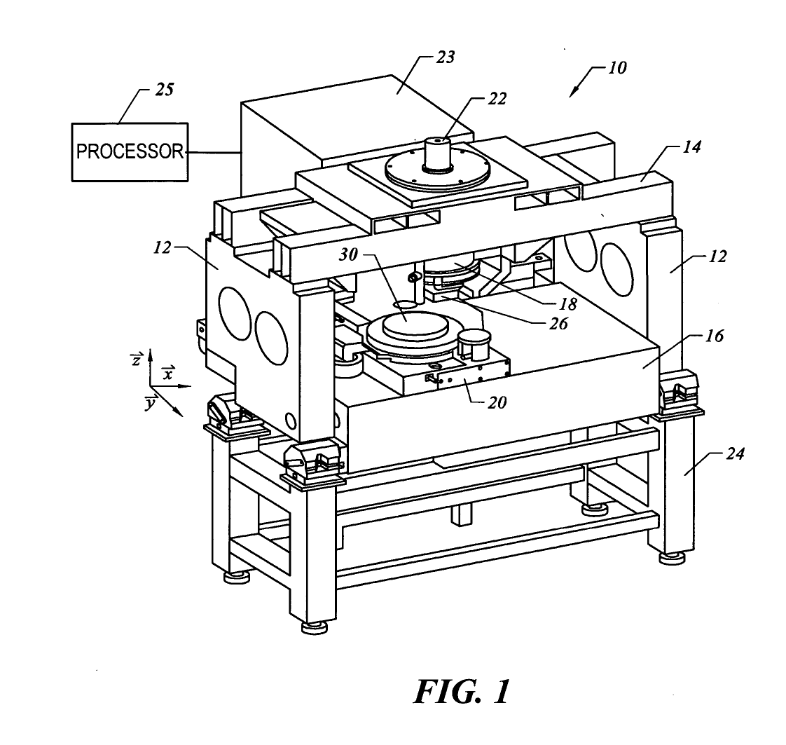

FIG. 1 depicts a lithographic system 10 in accordance with one embodiment of the present invention that includes a pair of spaced-apart bridge supports 12 having a bridge 14 and a stage support 16 extending therebetween. Bridge 14 and stage support 16 are spaced-apart. Coupled to bridge 14 is an imprint head 18, which extends from bridge 14 toward stage support 16 and provides movement along the Z-axis. Disposed upon stage support 16 to face imprint head 18 is a motion stage 20. Motion stage 20 is configured to move with respect to stage support 16 along X- and Y-axes. It should be understood that imprint head 18 may provide movement along the X- and Y-axes, as well as the Z-axis, and motion stage 20 may provide movement in the Z-axis, as well as the X- and Y-axes. An exemplary motion stage device is disclosed in U. S. patent application No. 10/194,414, filed Jul. 11, 2002, entitled “Step and Repeat Imprint Lithography Systems,” assigned to the assignee of the present invention, and which is incorporated by reference herein in it's entirety. A radiation source 22 is coupled to system 10 to impinge actinic radiation upon motion stage 20. As shown, radiation source 22 is coupled to bridge 14 and includes a power generator 23 connected to radiation source 22. Operation of system 10 is typically controlled by a processor 25 that is in data communication therewith.

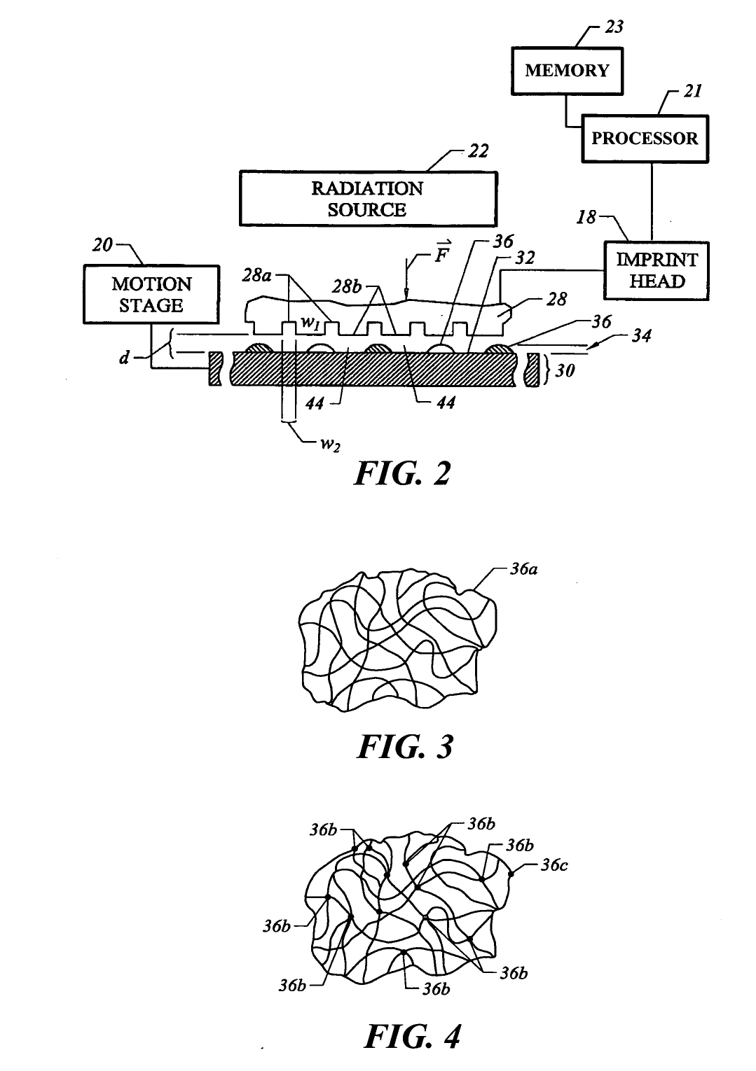

Referring to both FIGS. 1 and 2, connected to imprint head 18 is a template 26 having a mold 28 thereon. Mold 28 includes a plurality of features defined by a plurality of spaced-apart recessions 28a and protrusions 28b. The plurality of features defines an original pattern that is to be transferred into a substrate 30 positioned on motion stage 20. To that end, imprint head 18 and/or motion stage 20 may vary a distance “d” between mold 28 and substrate 30. In this manner, the features on mold 28 may be imprinted into a flowable region of substrate 30, discussed more fully below. Radiation source 22 is located so that mold 28 is positioned between radiation source 22 and substrate 30. As a result, mold 28 is fabricated from material that allows it to be substantially transparent to the radiation produced by radiation source 22. To that end, mold 28 may be formed from materials that includes quartz, fused-silica, silicon, sapphire, organic polymers, siloxane polymers, borosilicate glass, fluorocarbon polymers or a combination thereof. Further template 26 may be formed from the aforementioned materials, as well as metal.

Referring to both FIGS. 2 and 3, a flowable region, such as an imprinting layer 34, is disposed on a portion of surface 32 that presents a substantially planar profile. An exemplary flowable region consists of imprinting layer 34 being deposited as a plurality of spaced-apart discrete droplets 36 of material 36a on substrate 30, discussed more fully below. An exemplary system for depositing droplets 36 is disclosed in U.S. patent application No. 10/191,749, filed Jul. 9, 2002, entitled “System and Method for Dispensing Liquids,” and which is assigned to the assignee of the present invention, and which is incorporated by reference herein in its entirety. Imprinting layer 34 is formed from a material 36a that may be selectively polymerized and cross-linked to record the original pattern therein, defining a recorded pattern. An exemplary composition for material 36a is disclosed in U. S. patent application number 10/789,319, filed Feb. 27, 2004 and entitled “Composition for an Etching Mask Comprising a Silicon-Containing Material,” which is incorporated by reference in its entirety herein. Material 36a is shown in FIG. 4 as being cross-linked at points 36b, forming cross-linked polymer material 36c.

Referring to FIGS. 2, 3 and 5, the pattern recorded in imprinting layer 34 is produced, in part, by mechanical contact with mold 28. To that end, distance “d” is reduced to allow imprinting droplets 36 to come into mechanical contact with mold 28, spreading droplets 36 so as to form imprinting layer 34 with a contiguous formation of material 36a over surface 32. In one embodiment, distance “d” is reduced to allow sub-portions 34a of imprinting layer 34 to ingress into and to fill recessions 28a.

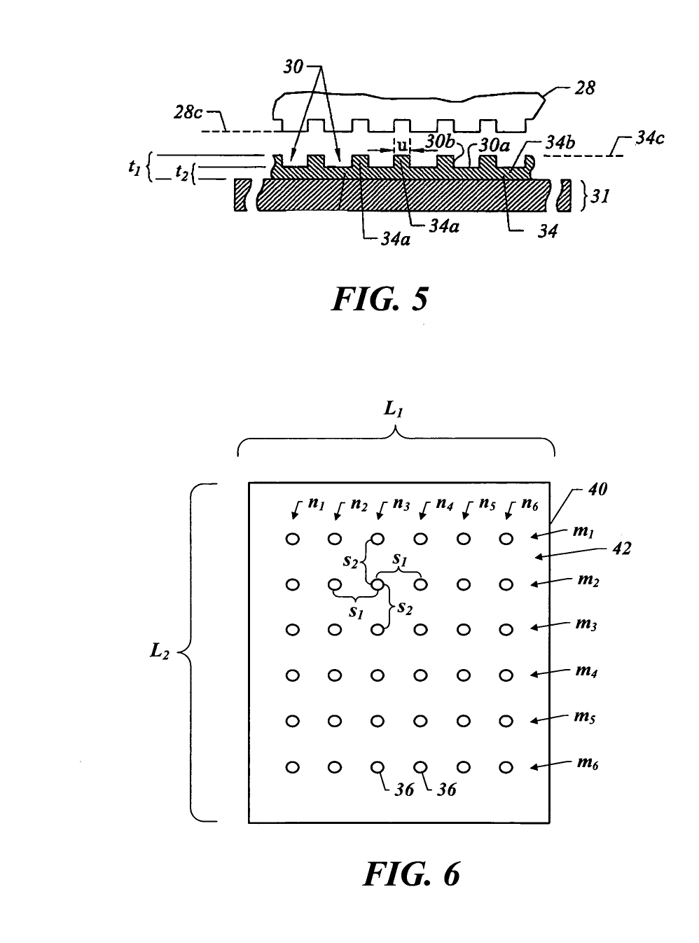

To facilitate filling of recessions 28a, material 36a is provided with the requisite properties to completely fill recessions 28a while covering surface 32 with a contiguous formation of material 36a. In the present embodiment, sub-portions 34b of imprinting layer 34 in superimposition with protrusions 28b remain after the desired, usually minimum, distance “d”, has been reached, leaving sub-portions 34a with a thickness t₁, and sub-portions 34b with a thickness t₂. Thicknesses t₁, and t₂ may be any thickness desired, dependent upon the application. Typically, t₁, is selected such that t₁-t₂<3u, shown more clearly in FIG. 5. Sub-portions 34b are typically referred to as a residual layer.

Referring to FIGS. 2, 3 and 4, after a desired distance “d” has been reached, radiation source 22 produces actinic radiation that polymerizes and cross-links material 36a, forming cross-linked polymer material 36c. As a result, the composition of imprinting layer 34 transforms from material 36a to cross-linked polymer material 36c, which is a solid. Specifically, cross-linked polymer material 36c is solidified to provide side 34c of imprinting layer 34 with a shape conforming to a shape of a surface 28c of mold 28, shown more clearly in FIG. 5. After imprinting layer 34 is transformed to consist of cross-linked polymer material 36c, shown in FIG. 4, imprint head 18, shown in FIG. 2, is moved to increase distance “d” so that mold 28 and imprinting layer 34 are spaced-apart.

Referring to FIG. 5, additional processing may be employed to complete the patterning of substrate 30. For example, substrate 30 and imprinting layer 34 may be etched to transfer the pattern of imprinting layer 34 into substrate 30, providing a patterned surface 34c. To facilitate etching, the material from which imprinting layer 34 is formed may be varied to define a relative etch rate with respect to substrate 30, as desired.

Referring to FIGS. 2, 3 and 6, for molds having very dense features, e.g., recessions 28a and protrusions 28b, on the order of nanometers, spreading droplets 36 over a region 40 of substrate 30 in superimposition with mold 28 to fill recessions 28a can require long periods of time, thereby slowing throughput of the imprinting process. To facilitate an increase in the throughput of the imprinting process, droplets 36 are dispensed to minimize the time required to spread over substrate 30 and to fill recessions 28a. This is achieved by dispensing droplets 36 as a two-dimensional matrix array 42 so that a spacing, shown as S₁, and S₂, between adjacent droplets 36 is minimized. As shown, droplets 36 of matrix array 42 are arranged in six columns n₁-n₆ and six rows m₁-m₆. However, droplets 36 may be arranged in virtually any two-dimensional arrangement on substrate 30. What is desired is maximizing the number of droplets 36 in matrix array 42, given a total volume, Vₜ, of material 36a necessary to form imprinting layer 34. This minimizes the spacing S₁ and S₂ between adjacent droplets of droplets 36. Further, it is desired that each of droplets 36 in the subset have substantially identical quantities of material 36a associated therewith, defined as a unit volume, Vᵤ. Based upon these criteria, it can be determined that the total number, n, of droplets 36 in matrix array 42 may be determined as follows:
n=Vₜ/Vᵤ, (1)
where Vₜ and Vᵤ are defined above. Assume a square array of droplets 36 where the total number, n, of droplets 36 is defined as follows:
n=n₁×n₂, (2)
where n₁, is that number of droplets along a first direction and n₂ is the number of droplets along a second direction. A spacing S₁ between adjacent droplets 36 along a first direction, i.e., in one dimension, may be determined as follows:
S₁=L₁/n₁, (3)
where L₁ is the length of region 40 along the first direction. In a similar fashion, a spacing S₂ between adjacent droplets 36 along a second direction extending transversely to the first direction may be determined as follows:
S₂=L₂/n₂, (4)
where L₂ is the length of region 40 along the second direction.

Considering that the unit volume of material 36a associated with each of droplets 36 is dependent upon the dispensing apparatus, it becomes clear that spacings S₁ and S2 are dependent upon the resolution, i.e., operational control of a droplet dispensing apparatus (not shown) employed to form droplets 36. Specifically, it is desired that the dispensing apparatus (not shown) be provided with a minimum quantity of material 36a in each of droplets 36 so that the same may be precisely controlled. In this fashion, the area of region 40 over which material 36a in each of droplets 36 must travel is minimized. This reduces the time required to fill recessions 28 and cover substrate with a contiguous layer of material 36a.

Dispensing droplets 36 may be achieved by either dispensing upon an entirety of substrate 30 at one time, or using either a field-to-field dispense technique, disclosed in U. S. patent application No. 10/194,414 that is the subject of U. S. patent publication No. 2004/0008334, the disclosure of which is incorporated by reference herein, or a combination of the two. To that end, the dispense system used may be either a piezo ink jet based technology or a micro solenoid based technology. As a result, the dispense system may be either a single nozzle, a linear array of nozzles, or a rectangular array of nozzles employed to dispense material 36a, with the linear and rectangular array of nozzles comprising greater than 100 individual jets. The nozzle array jets may dispense with a frequency of up to 4 kHz. Nozzle array jets are available either with on-off volume control or with gray scale volume control capability, wherein the gray scale volume control capability may dispense volumes ranging from 1 to 42 pico-liters (pL). When employing the field-to-field dispense technique, each nozzle of the nozzle array may dispense substantially the same composition of material 36a, however, in a further embodiment, each nozzle of the nozzle array may dispense differing compositions of material 36a.

Examples of inkjets include the Omnidot available from the Xaar Corporation headquartered in Cambridge, UK and inkjets available from Spectra, a division of the Dimatix Corporation headquartered in Lebanon, New Hampshire. An exemplary nozzle array is a multi-jet nozzle system that includes 126 jets and is sold under the part number XJ126 by Xaar Corporation. Furthermore, an atomization spray process using an ultrasonic spray head to dispense droplets 36 may be employed. Additionally, for material 36a comprising high viscosities, e.g., 20 centipose or greater, the Leopard available from the Xaar Corporation may be employed, wherein material 36a may be heated to reduce the viscosity of the same to a jettable range.

In order to obtain a thin and uniform residual layer, and minimize the time taken to imprint a field, there are several approaches that may be employed in accordance with the present invention.

Referring to FIGS. 1-3 and 7, for example, droplets 36 may be dispensed as a function of the design of template 26 and using suitable environmental gas (such as He) to eliminate trapped gases in imprinting layer 34. One embodiment for dispensing material 36a as a function of the design of template 26 is described here. Droplets 36 may comprise a small volume Vₛ, e.g., on the order of 1-1000pL. First, consider the case of template 26 absent of features. To achieve a given residual layer thickness on substrate 30, at step 100, compute the total volume V₁, of material 36a required, assuming that template 26 confines all of material 36a to an active area of template 26. Assuming a grid geometry of ‘m’ rows and ‘n’ columns, at step 102, compute ‘m’ and ‘n’ such that m×n×Vₛ=Vₗ. Once ‘m’ and ‘n’ are chosen, at step 104, identify the polygonal area around each grid point which represents the control region A_{c} that has an area of approximately the total area of the active field of template 26 divided by (m×n). At step 106, dispense a volume=V_{S} at each grid location where template 26 is not recessed (no features) over the control region A_{c}. At step 108, at grid points where the control region A_{c} is completely recessed on template 26 dispense a volume =(Vₛ+A_{c}×d), where d is the etch depth of template 26. At step 110, at grid points where a portion (say J%) of the control region A_{c} is recessed on template 26, dispense a volume=(Vₛ+A_{c}×d×J/100), where d is the etch depth of template 26.

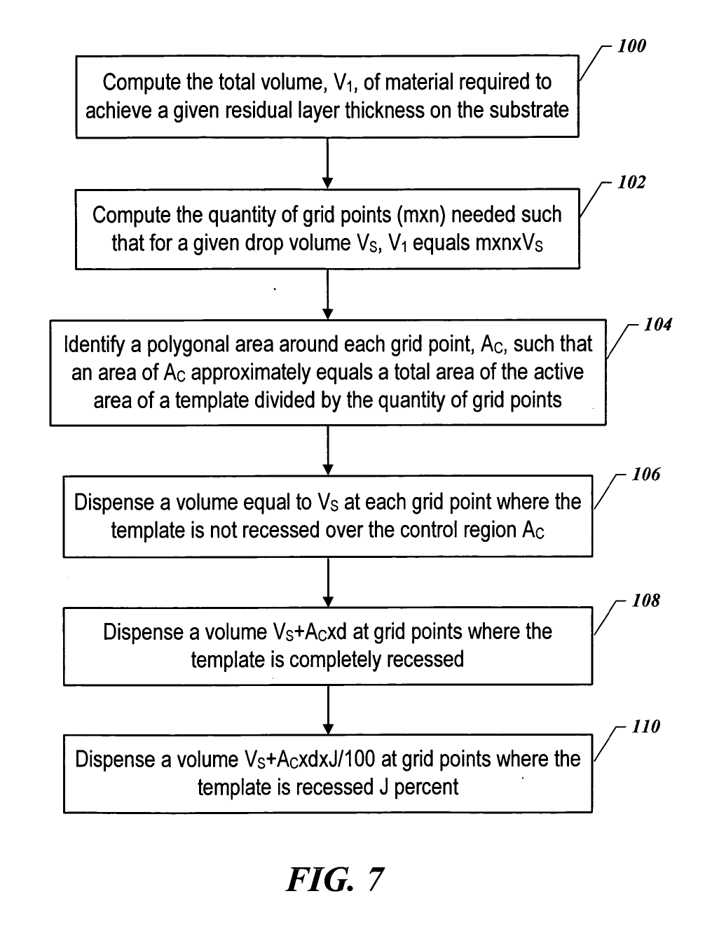

Referring to FIGS. 2 and 7, operation of imprint head 18 and the dispensing of droplets 60 may be controlled by a processor 21 that is in data communication therewith. A memory 23 is in data communication with processor 21. Memory 23 comprises a computer-readable medium having a computer-readable program embodied therein. The computer-readable program includes instructions to employ the above algorithm show in FIG. 7, or something similar to it to calculate the volume to be dispense at each grid point. Such software programs may process template design files (such as a GDS II file) that may be used to fabricate template 26.

Referring to FIGS. 2, 3, and 7, the volume to be dispensed at each control region A_{c} may be achieved by either, for a given volume per droplet of droplets 36, varying a pattern of droplets 36 within each control region A_{c}, or, for a given pattern of droplets 36, varying the volume per droplet of droplets 36 within each control region A_{c}, or a combination of the two. Furthermore, an empirical determination of the drop pattern and/or volume per droplet may be employed to obtain the desired characteristics of a transition region defined between adjacent control regions A_{c}.

The above approach provides the requisite material 36a in a region of substrate 30 while minimizing a distance traveled by material 36a in a droplet of droplets 36 prior to merging with material 36a in an adjacent droplet of droplets 36, and thus, decreasing the time needed for droplets 36 to fill recessions 28a. Upon merger of two or more droplets 36, there is a probability that gas pockets will be generated in imprinting layer 34 proximate to the boundaries of the merging material 36a.

It is desired to minimize the time for droplets 36 to fill recessions 28a, defined as the “fill time” of template 26, while creating imprinting layer 34 substantially absent of voids. To minimize the fill time of template 26, the time required for material 36a to displace the aforementioned gas pockets between the merging material 36a may be minimized. To that end, assuming each of droplets 36 comprises substantially the same volume, a mean and a variance of the volume of the gas pockets may be minimized. As a result, the gas pockets may be displaced at a faster rate by merging material 36a. An example of a pattern of droplets 36 to minimize the mean and the variance of the volume of the gas pockets may include, but is not limited to, hexagonal and triangular. Further, it was found that for a residual layer thickness of 30-40 nm or less, the fill time of template 26 was acceptable.

Additionally, minimizing the aforementioned distance traveled by material 36a in a droplet of droplets 36 prior to merging with material 36a in an adjacent droplet of droplets 36 reduces a viscous drag of material 36a resulting in a greater velocity of material 36a and a greater force to displace the gas pockets, and thus, further minimizing the fill time of template 26. Furthermore, were the gas pockets small volume regions, on the order of microns in lateral dimensions and submicron in thickness, the gas pockets may rapidly dissipate allowing for a fast imprint process.

To further minimize the fill time, a rate of displacement of the gas pockets may be increased such that the merging material 36a may displace the same at a faster rate. To that end, the rate of displacement of the gas pockets is proportional to a hydraulic pressure exerted on the same. The hydraulic pressure may be a function of a capillary force and any external force applied to droplets 36. To increase the hydraulic pressure, the capillary force may be increased, wherein the capillary force may be maximized by minimizing thickness t₂, shown in FIG. 5.

It should be noted that the volume dispensed in droplets 36 vary as a function of temperature. For example, the viscosity of material 36a may change, as well as the dimensions of the PZT material that actuates the pump that causes material 36a to egress from a nozzle, both of which vary the volume in a given droplet of droplets 36. Piezo micro-jets may include an in-built temperature sensor, as is the case with Xaar's 126 linear array, which continuously controls the temperature of the pump. A calibration curve that relates temperature and voltage can be developed to maintain a particular volume output. This calibration curve can be used in real-time to adjust the voltage level as temperature variations are observed.

Additionally, to avoid sporadic failure leading to missing droplets 36, a dispensing technique may be employed in which a subset or each droplet of droplets 36 is formed by dispensing of material 36a multiple times in a common location from a nozzle so that in the aggregate, each of droplets 36 is provided with a desired volume. Specifically, the volume of a given droplet of droplets 36 may be an average of the multiple volumes dispensed from the nozzle at the common location.

Further, for a given region on substrate 30, multiple droplets 36 coalesce in such a manner that the droplet local film thickness is an average of over N droplets 36, thereby if 1 droplet of droplets 36 never gets dispensed, then the local film thickness is (desired film thickness/N) nm different from ideal. Therefore, as far as N is sufficiently high (say 100), then the affect of a missing droplet of droplets 36 becomes negligible. As an example, for a field size of X mm by X mm, to establish a 100 nm residual layer, the minimum volume required is (0.1×X²) nL, wherein template 26 has no features in it. If template 26 comprises features, more material 36a would be needed, thereby further increasing N. Therefore, the case of template 26 absent of features is the worst case. The piezo jets can provide a volume as low as 1 pL. If we assume 80 pL as our basic drop unit, then the RLT error in nm is inversely proportional to the square of the characteristic length of the field size—l_{f}—in mm (defined as square root of the field area in mm² to include polygonal field regions). This is shown as follows:

[image]

If the allowable film thickness variation is 5 nm due to a missing droplet of droplets 36, then 1f is approximately 4 mm, which is independent of the resulting thickness of imprinting layer 34.

It should be noted that as the volume of droplets 36 decrease, the effects of evaporation increase. By calibrating the level of evaporation in droplets 36, the dispense volume can be increased to compensate for the evaporation. For example, more material 36a may be needed in regions of substrate 30 where droplets 36 are dispensed first as compared to regions where droplets 36 are dispensed last. Droplets 36 that are dispensed first evaporate more because it takes longer before template 26 and substrate 30 capture the liquid between them.

Referring to FIGS. 3 and 5, in a further embodiment, droplets 36 may comprise a surfactant pre-conditioning solution. The surfactant pre-conditioning solution may be employed such that when droplets 36 contact template 26, a portion of the surfactant pre-conditioning solution may adhere thereto. Droplets 36, comprising the surfactant pre-conditioning solution, may be positioned upon substrate 30 in a pattern to decrease the fill time of template 26, employing the methods as mentioned above. However, in a further embodiment, droplets 36 may be positioned upon substrate 30 in a pattern to counteract an accumulation of surfactant that may occur where adjacent droplets 36 merge and to facilitate droplets 36 filling recessions 28a.

In a further embodiment, it may be desired to position an underlayer (not shown) between substrate 30 and droplets 36. The underlayer (not shown) may comprise a composition having a low surface energy interaction with template 26 and a high surface energy interaction with droplets 36. The composition of the underlayer (not shown) may have minimal evaporation rates and a viscosity of approximately 10-100 cps to facilitate spin-on deposition thereof. The underlayer (not shown) and droplets 36 may be miscible, and the underlayer (not shown) may be a solvent for droplets 36.

The embodiments of the present invention described above are exemplary. Many changes and modifications may be made to the disclosure recited above, while remaining within the scope of the invention. Therefore, the scope of the invention should not be limited by the above description, but instead should be determined with reference to the appended claims along with their full scope of equivalents.

1. A method for dispensing a total volume of liquid on a substrate, said method comprising:
disposing a plurality of spaced-apart droplets on a region of said substrate, each having an unit volume associated therewith, with an aggregate volume of said droplets in said region being a function of a volume of a pattern to be formed thereat.

2. The method as recited in claim 1 wherein said volume of said pattern is dependent upon a thickness of a residual layer to be formed on said region.

3. The method as recited in claim 1 wherein said volume of said pattern is dependent upon a size of a feature to be formed at said region.

4. The method as recited in claim 1 wherein said volume of said pattern is dependent upon a thickness of a residual layer to be formed on said region and a size of a feature to be formed at said region.

5. The method as recited in claim 4 wherein said volume of said pattern is further dependent upon a percentage of said region comprising said feature.

6. The method as recited in claim 1 wherein disposing further includes dispensing a plurality of volumes of a material to form one of said plurality of spaced-apart droplets.

7. The method as recited in claim 1 wherein disposing further includes dispensing said plurality of spaced-apart droplets so as to compensate for evaporative loss of said plurality of spaced-apart droplets during patterning processes.

8. The method as recited in claim 1 wherein disposing further includes minimizing a spacing between one of said plurality of spaced-apart droplets and an adjacent droplet of said plurality of spaced-apart droplets.

9. The method as recited in claim 1 wherein said plurality of spaced-apart droplets has a pattern selected from a group consisting essentially of hexagonal and triangular.

10. A method for dispensing a total volume of liquid on a substrate, said method comprising:
disposing a first set of a plurality of spaced-apart droplets on a first region of said substrate, each having an unit volume associated therewith, with an aggregate volume of said first set of droplets in said first region being a function of a volume of a first pattern to be formed thereat; and
disposing a second set of a plurality of spaced-apart droplets on a second region of said substrate, each having an unit volume associated therewith, with an aggregate volume of said second set of droplets in said second region being a function of a volume of a second pattern, differing from said first pattern, to be formed thereat.

11. The method as recited in claim 10 wherein said volume of said first pattern is dependent upon a thickness of a residual layer to be formed on said first region.

12. The method as recited in claim 10 wherein said volume of said second pattern is dependent upon a thickness of a residual layer to be formed on said second region and a size of a feature to be formed at said region.

13. The method as recited in claim 10 wherein said volume of said first and said second patterns are dependent upon a thickness of a residual layer to be formed on said first and second regions, with said second pattern further being dependent upon a size of a feature to be formed on said second region.

14. The method as recited in claim 13 wherein said volume of said second pattern is further dependent upon a percentage of said second region comprising said feature.

15. The method as recited in claim 10 wherein disposing further includes dispensing a plurality of volumes of a material to form one of said plurality of spaced-apart droplets.

16. A method for dispensing a total volume of liquid on a substrate, said method comprising:
disposing a plurality of spaced-apart droplets on a region of said substrate, each having an unit volume associated therewith, with an aggregate volume of said droplets in said region being a function of a volume of a thickness of a residual layer to be formed on said region and a volume of a pattern to be formed on said residual layer.

17. The method as recited in claim 16 wherein said volume of said pattern is dependent upon a size of a feature to be formed at said region.

18. The method as recited in claim 17 wherein said volume of said pattern is further dependent upon a percentage of said region comprising said feature.

19. The method as recited in claim is wherein disposing further includes dispensing a plurality of volumes of a material to form one of said plurality of spaced-apart droplets.

20. The method as recited in claim 19 wherein disposing further includes dispensing said plurality of spaced-apart droplets so as to compensate for evaporative loss of said plurality of spaced-apart droplets during patterning processes.

21. A method for dispensing a liquid on a substrate, said method comprising;
disposing a pattern of a plurality of spaced-apart droplets on said substrate, said plurality of droplets defining a plurality of gas pockets between adjacent droplets, with said pattern being established such that a volume of said plurality of gas pockets is minimized.

22. The method as recited in claim 21 wherein said pattern is further established such that a mean of said volume of each of said plurality of gas pockets is minimized.

23. The method as recited in claim 21 wherein said pattern is further established such that a mean and a variance of said volume of each of said plurality of gas pockets is minimized.

24. The method as recited in claim 21 wherein disposing said pattern further includes positioning said plurality of spaced-apart droplets in a pattern selected from a group consisting essentially of hexagonal and triangular.

25. The method as recited in claim 21 wherein each of said plurality of spaced-apart droplets comprises substantially the same volume.

26. The method as recited in claim 21 wherein disposing further includes dispensing a plurality of volumes of a material to form one of said plurality of spaced-apart droplets.

27. The method as recited in claim 21 wherein disposing further includes dispensing said plurality of spaced-apart droplets so as to compensate for evaporative loss of said plurality of spaced-apart droplets during patterning processes.

28. The method as recited in claim 21 wherein disposing further includes minimizing a spacing between one of said plurality of spaced-apart droplets and an adjacent droplet of said plurality of spaced-apart droplets .
